(19) United States
(12) Patent Application Publication
(10) Pub. No.: US 2014/0335441 A1
(43) Pub. Date: Nov. 13, 2014

(54) METHOD FOR PRODUCING POROUS METALLIC BODY AND POROUS METALLIC BODY

(71) Applicant: SUMITOMO ELECTRIC TOYAMA CO., LTD., Imizu-shi, Toyama (JP)

(72) Inventors: Kengo Tsukamoto, Imizu-shi (JP); Hitoshi Tsuchida, Imizu-shi (JP); Hidetoshi Saito, Imizu-shi (JP); Junichi Nishimura, Osaka-shi (JP)

(21) Appl. No.: 14/365,169

(22) PCT Filed: Dec. 4, 2012
(86) PCT No.: PCT/JP2012/081331

§ 371 Date: Jun. 13, 2014

(30) Foreign Application Priority Data
Dec. 27, 2011 (JP) 2011-284870

(51) Int. Cl. C25D 1/08; H01G 11/68; H01M 4/66; H01M 4/80; H01M 8/02

(52) U.S. Cl. CPC C25D 1/08; H01M 4/80; H01M 8/0232; H01M 4/662; H01G 11/68
USPC 429/522; 205/75; 429/235; 361/500

(57) ABSTRACT

A method for producing a porous metallic body at least includes a step of forming an electrically conductive coating layer on a surface of a skeleton of a three-dimensional network resin having a continuous pore by coating the surface with a coating material containing a carbon powder having a volume-average particle size of 10 μm or less and at least one fine powder having a volume-average particle size of 10 μm or less and selected from the group consisting of metal fine powders and metal oxide fine powders; a step of forming at least one metal plating layer; and a step of performing a heat treatment to remove the three-dimensional network resin and to cause reduction and thermal diffusion in the at least one metal or metal oxide fine powder and the at least one metal plating layer.

### TECHNICAL FIELD

The present invention relates to a porous metallic body that is usable as, for example, a collector for a battery, a filter, or a catalyst carrier, that is excellent in terms of strength and toughness, and that is produced at a low cost and from a wide range of materials; and a method for producing the porous metallic body.

### BACKGROUND ART

Conventionally, porous metallic bodies are used in various applications including collectors for batteries, filters, and catalyst carriers. Thus, as described below, there are a large number of known documents relating to techniques of producing porous metallic bodies.

Patent Literature 1 proposes a high-strength porous metallic body that is obtained by applying a coating material containing strength-enhancing fine particles formed of an oxide, a carbide, a nitride, or the like of an element in group II to VI in the periodic table to the surface of the skeleton of a three-dimensional network resin having a continuous pore, by further forming a metal plating layer of a Ni alloy or a Cu alloy on the coating film of the coating material, and by subsequently performing a heat treatment to diffuse the fine particles into the metal plating layer. However, since the strength-enhancing fine particles are diffused within the metal plating layer serving as the base layer, the porous metallic body has a high breaking strength but has a low breaking extension. Accordingly, the porous metallic body is vulnerable to processing involving plastic deformation such as bending or pressing and is broken, which is problematic.

Patent Literatures 2 to 4 propose a porous metallic body that is obtained by coating or spraying a three-dimensional network resin with a slurry containing a metal or metal oxide powder and a resin and by performing drying and then a sintering treatment. However, in such a porous metallic body produced by a sintering method, the skeleton is formed through sintering of metal or metal oxide powder particles. Accordingly, even when the powder has a small particle size, several voids are formed in sections of the skeleton. As a result, even when a body having a high breaking strength is obtained on the basis of a design using a single metal or an alloy, the body has a low breaking extension similarly to above. Thus, the body is vulnerable to processing involving plastic deformation such as bending or pressing and is broken, which is problematic.

Patent Literatures 5 and 6 propose a porous metallic body that is obtained as follows: a three-dimensional network resin that is made electrically conductive is used as a support and treated by a plating method to form a Ni porous body; this Ni porous body is treated by cementation in which the body is embedded in a powder containing Cr or Al and NH₄Cl and heat-treated in Ar or H₂ gas atmosphere. However, cementation has low productivity and hence incurs a high cost; in addition, elements that can be alloyed with a Ni porous body are limited to Cr and Al, which are problematic.

Accordingly, there has been a demand for a porous metallic body that is suitable as, for example, a collector for a battery, a filter, or a catalyst carrier, that is excellent in terms of strength and toughness, and that is produced at a low cost and from a wide range of materials; and a method for producing the porous metallic body.

### CITATION LIST

### Patent Literature

PTL 1: Japanese Unexamined Patent Application Publication No. 07-150270

PTL 2: Japanese Examined Patent Application Publication No. 38-17554

PTL 3: Japanese Unexamined Patent Application Publication No. 09-017432

PTL 4: Japanese Unexamined Patent Application Publication No. 2001-226723

PTL 5: Japanese Unexamined Patent Application Publication No. 08-013129

PTL 6: Japanese Unexamined Patent Application Publication No. 08-232003

### SUMMARY OF INVENTION

### Technical Problem

In view of the above-described problems, an object of the present invention is to provide a porous metallic body that is suitable as, for example, a collector for a battery, a filter, or a catalyst carrier, that is excellent in terms of strength and toughness, and that is produced at a low cost and from a wide range of materials; and a method for producing the porous metallic body.

### Solution to Problem

The inventors of the present invention performed thorough studies on how to achieve the object. As a result, the inventors have found the following feature effective: the surface of a skeleton of a three-dimensional network resin having a continuous pore is coated with a coating material containing a carbon powder having a volume-average particle size of 10 μm or less and at least one fine powder having a volume-average particle size of 10 μm or less and selected from the group consisting of metal fine powders and metal oxide fine powders; at least one metal plating layer is further formed on the coating film of the coating material; and a heat treatment is then performed to remove the three-dimensional network resin and to cause reduction and alloy formation by thermal diffusion in the at least one metal or metal oxide fine powder and the at least one metal plating layer. Thus, the inventors have accomplished the present invention. Specifically, embodiments of the present invention are as follows.
(1) A method for producing a porous metallic body, the method at least including:

a step of forming an electrically conductive coating layer on a surface of a skeleton of a three-dimensional network resin having a continuous pore by coating the surface with a coating material containing a carbon powder having a volume-average particle size of 10 μm or less and at least one fine powder having a volume-average particle size of 10 μm or less and selected from the group consisting of metal fine powders and metal oxide fine powders;

a step of forming at least one metal plating layer; and

a step of performing a heat treatment to remove the three-dimensional network resin and to cause reduction and thermal diffusion in the at least one metal or metal oxide fine powder and the at least one metal plating layer.
(2) The method for producing a porous metallic body according to (1), wherein the coating material contains at least one metal fine powder having a volume-average particle size of 10 μm or less and formed of a metal selected from the group consisting of Al, Ti, Cr, Mn, Fe, Co, Ni, Cu, Mo, Sn, and W.
(3) The method for producing a porous metallic body according to (1), wherein the coating material contains at least one metal oxide fine powder having a volume-average particle size of 10 μm or less and formed of a metal oxide selected from the group consisting of Al₂O₃, TiO₂, Cr₂O₃, MnO₂, Fe₂O₃, CO₃O₄, NiO, CuO, MoO₃, SnO₂, and WO₃.
(4) The method for producing a porous metallic body according to any one of (1) to (3), wherein the at least one metal plating layer is formed of a metal selected from the group consisting of Al, Al alloy, Cr, Cr alloy, Fe, Fe alloy, Ni, Ni alloy, Cu, Cu alloy, Zn, Zn alloy, Sn, and Sn alloy.
(5) The method for producing a porous metallic body according to any one of (1) to (4), wherein, in the heat-treatment step, the at least one metal or metal oxide fine powder and the at least one metal plating layer are reduced with the carbon powder contained in the electrically conductive coating layer.
(6) The method for producing a porous metallic body according to any one of (1) to (5), wherein the thermal diffusion causes alloy formation.
(7) A porous metallic body produced by the method for producing a porous metallic body according to any one of (1) to (6).
(8) The porous metallic body according to (7), wherein the porous metallic body is formed of Ni—Al, Ni—Cr, Ni—Mn, Ni—W, Ni—Co, Ni—Sn, Al, Ni—Mo, Ni—Ti, Fe—Cr—Ni, or Fe—Cr—Ni—Mo.
(9) A porous metallic body having a continuous pore,

wherein the porous metallic body is formed of at least one metal selected from the group consisting of Al, Ti, Cr, Mn, Fe, Co, Ni, Cu, Mo, Sn, and W,

a relationship between a thickness t of a skeleton of the porous metallic body and an average crystal grain diameter D in the skeleton satisfies a formula described below,

an oxygen concentration in metal is less than 0.5 wt %, and

a section of the skeleton has a porosity of less than 1%

]t/D<1.0.

### ADVANTAGEOUS EFFECTS OF INVENTION

The present invention can provide a porous metallic body that is suitable as, for example, a collector for a battery, a filter, or a catalyst carrier, that is excellent in terms of strength and toughness, and that is produced at a low cost and from a wide range of materials; and a method for producing the porous metallic body.

### BRIEF DESCRIPTION OF DRAWINGS

FIG. 1(a) is an enlarged external view of a porous metallic body according to the present invention.

FIG. 1(b) is a sectional view of the skeleton of a porous metallic body.

FIG. 2(a) is a sectional view of a skeleton obtained by coating the surface of a three-dimensional network resin with an electrically conductive coating material containing a carbon powder and a metal or metal oxide fine powder.

FIG. 2(b) is a sectional view of a skeleton obtained by plating the coating film in FIG. 2(a) with metal.

### DESCRIPTION OF EMBODIMENTS

A method for producing a porous metallic body having a three-dimensional network structure according to the present invention at least includes a step of forming an electrically conductive coating layer on a surface of a skeleton of a three-dimensional network resin having a continuous pore by coating the surface with a coating material containing a carbon powder having a volume-average particle size of 10 μm or less and at least one fine powder having a volume-average particle size of 10 μm or less and selected from the group consisting of metal fine powders and metal oxide fine powders; a step of forming at least one metal plating layer; and a step of performing a heat treatment to remove the three-dimensional network resin and to cause reduction and thermal diffusion in the at least one metal or metal oxide fine powder and the at least one metal plating layer. This allows appropriate production of a porous metallic body having a three-dimensional network structure according to the present invention.

### (Porous Resin Body)

The three-dimensional network resin may be a resin foam, nonwoven fabric, felt, woven fabric, or the like; and, if necessary, these may be used in combination. The material is not particularly limited; however, a material that can be plated with metal and then can be removed by incineration is preferred. In particular, when a porous resin body having the form of a sheet is highly stiff, it may break during handling. Accordingly, the material is preferably flexible.

In the present invention, a resin foam is preferably used as the three-dimensional network resin. The resin foam may be a publicly known or commercially available resin foam as long as it is a porous resin foam. Examples of such a resin foam include a urethane foam and a styrene foam. Of these, a urethane foam is particularly preferred in view of a high porosity. The thickness, porosity, and average pore size of such a resin foam are not limited and can be appropriately determined in accordance with the application.

### (Electrically Conductive Treatment)

An electrically conductive coating material for forming an electrically conductive coating layer on the surface of the three-dimensional network resin can be obtained by adding a binder to a metal or metal oxide fine powder and a carbon powder.

The metal or metal oxide fine powder preferably has a volume-average particle size of 10 μm or less. The fine powder is preferably formed of a material that can be thermally diffused at 1500° C. or less and is excellent in terms of corrosion resistance and mechanical strength. Preferred examples of the metal include Al, Ti, Cr, Mn, Fe, Co, Ni, Cu, Mo, Sn, and W. Preferred examples of the metal oxide include Al₂O₃, TiO₂, Cr₂O₃, MnO₂, Fe₂O₃, CO₃O₄, NiO, CuO, MoO₃, SnO₂, and WO₃. Metal oxide fine powders are advantageously used because, for example, raw materials of some metal oxides are less expensive and some metal oxides are easily formed into fine powders.

When the metal or metal oxide fine powder has a volume-average particle size of more than 10 μm, the continuous pore of the three-dimensional network resin tends to be clogged with the electrically conductive coating material. In addition, after thermal diffusion, local concentration gradients of alloy are formed. For this reason, the fine powder preferably has a volume-average particle size of 10 μm or less.

The carbon powder preferably has a volume-average particle size of 10 μm or less. The material of the carbon powder is, for example, crystalline graphite or amorphous carbon black. Of these, graphite is particularly preferred because, in general, graphite tends to have a small particle size. When the carbon powder has a volume-average particle size of more than 10 μm, the density of the carbon particles becomes low and the electrical conductivity becomes poor, which is disadvantageous in the subsequent metal plating step. In addition, the continuous pore of the three-dimensional network resin tends to be clogged with the electrically conductive coating material. Moreover, the capability of being pyrolyzed in the heat-treatment step is degraded. For these reasons, the powder preferably has a volume-average particle size of 10 μm or less.

As long as the electrically conductive coating layer is continuously formed on the surface of the three-dimensional network resin, the coating weight of the layer is not limited and is generally about 0.1 to about 300 g/m², preferably 1 to 100 g/m².

### (Metal Plating Step)

The metal plating step can be performed by a publicly known plating method that is not particularly limited, preferably by an electroplating method. Instead of the electroplating treatment, use of an electroless plating treatment and/or a sputtering treatment for increasing the thickness of a plating film may eliminate the necessity of performing the electroplating treatment. However, the electroless plating treatment and the sputtering treatment are not preferred in terms of productivity and cost. For this reason, as described above, the step of making a porous resin body electrically conductive is performed and then a metal layer is formed by an electroplating method. As a result of this process, a porous metallic body can be produced with high productivity and at a low cost such that sections of the skeleton have a porosity of less than 1% with high stability.

Examples of the material of the metal plating layer include Al, Al alloy, Cr, Cr alloy, Fe, Fe alloy, Ni, Ni alloy, Cu, Cu alloy, Zn, Zn alloy, Sn, and Sn alloy because of high productivity.

The electroplating treatment may be performed in a standard manner. Plating baths may be publicly known or commercially available baths. Examples of plating baths include, for Al/Al alloy, an aluminum molten salt bath; for Cr/Cr alloy, a sergeant bath, a fluoride bath, and a trivalent chromium bath; for Fe/Fe alloy, a chloride bath, a sulfate bath, a fluoroborate bath, and a sulfamate bath; for Ni/Ni alloy, a Watts bath, a chloride bath, and a sulfamate bath; for Cu/Cu alloy, a sulfate bath, a cyanide bath, and a pyrophosphate bath; for Zn/Zn alloy, a cyanide bath and a zincate bath; and, for Sn/Sn alloy, a fluoroborate bath, a phenolsulfonate bath, and a halide bath.

The three-dimensional network resin having the electrically conductive coating layer is immersed in a plating bath and connected to a cathode. A counter electrode plate formed of a metal for plating is connected to an anode. Direct current or pulse current is passed between the cathode and the anode to thereby form a metal plating coating on the electrically conductive coating layer.

The metal plating layer should be formed on the electrically conductive coating layer such that the electrically conductive coating layer is not exposed. The coating weight of the metal plating layer is not limited and may be generally about 100 to about 600 g/m², preferably about 200 to about 500 g/m².

### (Heat-Treatment Step)

The porous metallic body obtained in the above-described step is heated at 500° C. to 1500° C. so that the three-dimensional network resin is removed by pyrolysis. At this time, by performing the heat treatment in a reducing atmosphere gas such as H₂ gas or N₂ gas, the metal or metal oxide fine powder and the metal plating layer can be reduced. The carbon powder contained in the electrically conductive coating layer functions as a strong reducing agent at high temperatures to reduce the metal or metal oxide fine powder and the metal plating layer.

The heat treatment performed at an optimal temperature for an optimal period in accordance with the metal species allows reduction of metal (decrease in the oxygen concentration in the metal) with the carbon powder, alloy formation due to thermal diffusion, and formation of coarse crystal grains. As a result, the strength and toughness can be increased to provide a high-strength porous metallic body that does not break even by processing involving plastic deformation such as bending or pressing.

When the heat-treatment temperature is less than 500° C., the three-dimensional network resin cannot be completely removed. In addition, reduction, alloy formation due to thermal diffusion, and formation of coarse crystal grains in the metal or metal oxide fine powder and the metal plating layer are not sufficiently achieved. Thus, the porous metallic body cannot bear practical usage in some cases. When the temperature is 1500° C. or more, some metal species are melted and the three-dimensional network structure cannot be maintained; or the body of the heat-treatment furnace may be damaged in a short period. Accordingly, the heat treatment is preferably performed at a temperature that is within the above-described range and equal to or less than the melting point of the metal.

By performing the above-described steps, a porous metallic body can be provided that is excellent in terms of strength and toughness and that is produced at a low cost and from a wide range of materials; and a method for producing the porous metallic body can be provided.

A porous metallic body according to the present invention can be obtained by the above-described steps. The porous metallic body is preferably formed of Ni—Al, Ni—Cr, Ni—Mn, Ni—W, Ni—Co, Ni—Sn, Al, Ni—Mo, Ni—Ti, Fe—Cr—Ni, or Fe—Cr—Ni—Mo.

A porous metallic body according to the present invention is a porous metallic body having a continuous pore, wherein the porous metallic body is formed of at least one metal selected from the group consisting of Al, Ti, Cr, Mn, Fe, Co, Ni, Cu, Mo, Sn, and W; a relationship between a thickness t (unit: μm) of a skeleton of the porous metallic body and an average crystal grain diameter D (unit: μm) in the skeleton satisfies “t/D≦1.0”; an oxygen concentration in metal is less than 0.5 wt %; and a section of the skeleton has a porosity of less than 1%. In this case, D satisfies D≧1.0. The thickness t of the skeleton can be appropriately set in accordance with the application of the porous metallic body as long as breakage, cracking, and the like do not occur in the skeleton of the porous metallic body and the skeleton can be normally maintained.

By performing the above-described method for producing a porous metallic body according to the present invention, the oxygen concentration in the porous metallic body can be decreased to less than 0.5 wt % with the carbon powder.

The inventors of the present invention further performed studies and, as a result, have found that the relationship between the thickness t of the skeleton of the porous metallic body and the average crystal grain diameter D in the skeleton preferably satisfies “t/D≦1.0”. That is, when the relationship between the thickness t of the skeleton of the porous metallic body and the average crystal grain diameter D in the skeleton satisfies this range, the state of the skeleton having a high breaking strength and a high breaking extension can be maintained. Such a porous metallic body can be obtained by appropriately adjusting the volume-average particle size of a metal or metal oxide fine powder having a volume-average particle size of 10 μm or less disposed on the surface of the skeleton of a three-dimensional network resin, and by appropriately adjusting the thickness of at least one metal plating layer subsequently formed in the form of the fine powder.

### EXAMPLES

Hereinafter, the present invention will be described in further detail with reference to Examples. However, these Examples are mere examples and a porous metallic body according to the present invention is not limited to these Examples. The scope of the present invention is indicated by Claims and is intended to embrace all the modifications within the meaning and range of equivalency of the Claims.

### EXAMPLES

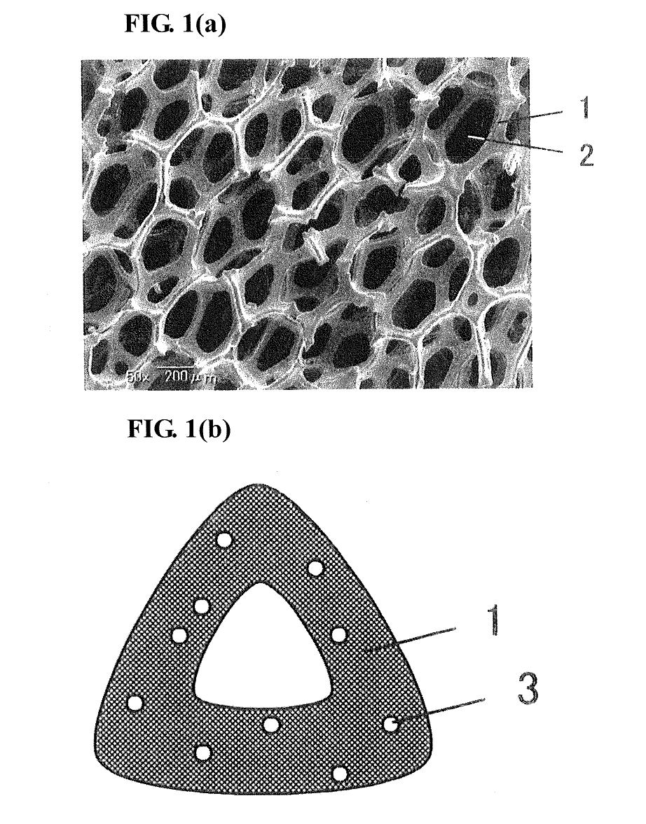

FIGS. 1(a) and 1(b) illustrate a porous metallic body according to an embodiment of the present invention. FIG. 1(a) is an enlarged external view of the porous metallic body. In this drawing, Reference sign 1 denotes a hollow metal skeleton having a three-dimensional network structure; and Reference sign 2 denotes a continuous pore. FIG. 1(b) is a schematic view illustrating a section of the metal skeleton 1. Reference sign 3 denotes voids present in the section of the skeleton.

### (Electrically Conductive Treatment for Three-Dimensional Network Resin)

A three-dimensional network resin that was a polyurethane foam sheet having a thickness of 1.5 mm (pore size: 0.45 mm) was first prepared. Subsequently, 100 g of graphite having a volume-average particle size in Table I and 100 g of a metal or metal oxide fine powder having a volume-average particle size in Table I were dispersed in a 0.5-L 10% aqueous solution of an acrylate resin to prepare a viscous coating material having such a composition ratio. Such metal or metal oxide fine powders used were formed of Al, Cr, Mn, W, Mo, Ti, Fe₂O₃, Co₃O₄, CuO, and SnO₂. In the cases where two or more metal or metal oxide fine powders were added, the fine powders were added in ratios such that the alloy compositions in Table I were achieved.

Subsequently, the polyurethane foam sheet was subjected to an electrically conductive treatment by being continuously immersed in the coating material, squeezed with a roll, and then dried. Thus, an electrically conductive coating layer was formed on the surface of the three-dimensional network resin. The viscosity of the electrically conductive coating material was adjusted with a thickening agent. The coating weight of the electrically conductive coating material was adjusted such that a desired alloy composition in Table I was achieved.

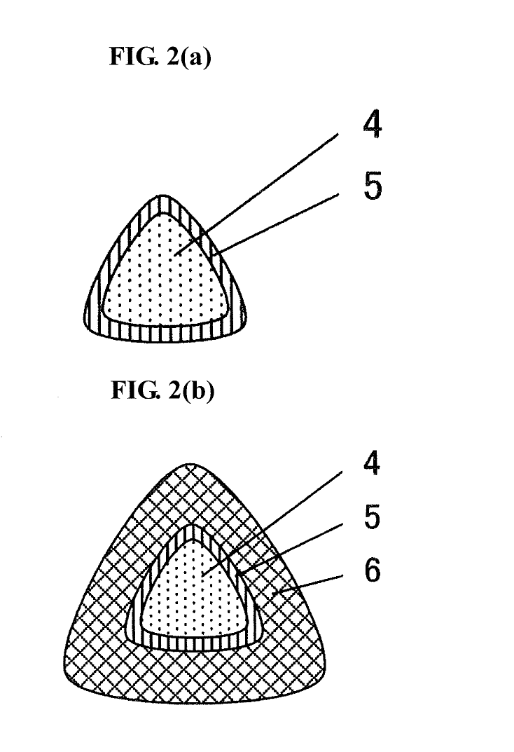

As a result of this step, as illustrated in FIG. 2(a), a coating film 4 of the electrically conductive coating material containing a carbon powder and a metal or metal oxide fine powder is formed on the surface of a three-dimensional network resin 3.

### (Metal Plating Step)

The three-dimensional network resin subjected to the electrically conductive treatment was electrically plated with 300 g/m² of Ni, Al, or Fe—Ni alloy to form an electroplating layer. Plating solutions used were a nickel sulfamate plating solution for Ni, a dimethylsulfone-aluminum chloride molten salt bath for Al, and a sulfate bath as a plating solution for Fe—Ni alloy plating.

As a result of this step, as illustrated in FIG. 2(b), a metal plating layer 5 is formed on the coating film 4 of the electrically conductive coating material containing a carbon powder and a metal or metal oxide fine powder.

### (Heat-Treatment Step)

Such porous metallic bodies obtained by the above-described steps were heated under the conditions in Table I to finally provide porous metallic bodies A-1 to A-15.

As a result of this step, the three-dimensional network resin 3 is removed by pyrolysis. The metal or metal oxide fine powder in the electrically conductive coating layer 4 and the metal plating layer 5 are reduced with the carbon powder contained in the electrically conductive coating layer 4. In addition, the metal component in the electrically conductive coating layer 4 is alloyed with the metal plating layer 5 by thermal diffusion. Thus, the section of the skeleton in FIG. (1)b is provided.

### COMPARATIVE EXAMPLES

### (Electrically Conductive Treatment for Three-Dimensional Network Resin)

A three-dimensional network resin that was a polyurethane foam sheet having a thickness of 1.5 mm (pore size: 0.45 mm) was prepared. Subsequently, 100 g of a metal or metal oxide fine powder having a volume-average particle size in Table I was dispersed in a 0.5-L 10% aqueous solution of an acrylate resin to prepare a viscous coating material having such a composition ratio. Such metal or metal oxide fine powders used were formed of Cr, Al, Mo, and CuO. In the case where two or more metal or metal oxide fine powders were added, the fine powders were added in a ratio such that the alloy composition in Table I was achieved.

Subsequently, the polyurethane foam sheet was subjected to an electrically conductive treatment by being continuously immersed in the coating material, squeezed with a roll, and then dried. Thus, an electrically conductive coating layer was formed on the surface of the three-dimensional network resin. The viscosity of the electrically conductive coating material was adjusted with a thickening agent. The coating weight of the electrically conductive coating material was adjusted such that a desired alloy composition in Table I was achieved.

### (Metal Plating Step)

The three-dimensional network resin subjected to the electrically conductive treatment was electrically plated with 300 g/m² of Ni, Al, or Fe—Ni alloy to form an electroplating layer. Plating solutions used were a nickel sulfamate plating solution for Ni, a dimethylsulfone-aluminum chloride molten salt bath for Al, and a sulfate bath as a plating solution for Fe—Ni alloy plating.

### (Heat-Treatment Step)

Such porous metallic bodies obtained by the above-described steps were heated under the conditions in Table I to finally provide porous metallic bodies B-1 to B-7.

TABLE I

| | Electrically conductive coating material | | | | | | | | |
|---|---|---|---|---|---|---|---|---|---|
| | Carbon powder | | Metal/metal oxide | | | | | | |
| | | Average | | Average | | Heat treatment | | | |
| | | particle | | particle | | | Tempera- | | |
| | | size | | size | | Atmo- | ture | Time | |
| Item | Type | [mm] | Type | [mm] | Plating | sphere | [° C.] | [min] | Alloy composition |
| A-1 | Graphite | 0.5 | Al | 10 | Ni | H₂/N₂ | 1000 | 50 | NiAl(Al30%) |
| A-2 | Graphite | 0.5 | Cr | 5 | Ni | H₂/N₂ | 1000 | 50 | NiCr(Cr30%) |
| A-3 | Graphite | 0.5 | Mn | 8 | Ni | H₂/N₂ | 1000 | 50 | NiMn(Mn30%) |
| A-4 | Graphite | 0.5 | W | 4 | Ni | H₂/N₂ | 1000 | 50 | NiW(W30%) |
| A-5 | Graphite | 0.5 | Fe₂O₃ | 1 | Ni | H₂ | 1100 | 30 | NiFe(Fe21%) |
| A-6 | Graphite | 0.5 | Co₃O₄ | 8 | Ni | H₂ | 1100 | 30 | NiCo(Co22%) |
| A-7 | Graphite | 0.5 | CuO | 2 | Ni | H₂ | 1100 | 30 | NiCu(Cu24%) |
| A-8 | Graphite | 0.5 | SnO₂ | 2 | Ni | H₂ | 1100 | 30 | NiSn(Sn23%) |
| A-9 | Graphite | 0.5 | Al | 10 | Al | H₂/N₂ | 1000 | 50 | Al |
| A-10 | Graphite | 0.5 | Mo | 2 | Ni | H₂/N₂ | 1000 | 50 | NiMo(Mo30%) |
| A-11 | Graphite | 0.5 | Ti | 5 | Ni | H₂/N₂ | 1000 | 50 | NiTi(Ti30%) |
| A-12 | Graphite | 0.5 | Cr | 5 | Fe/Ni | H₂/N₂ | 1000 | 50 | FeCrNi |
| | | | | | | | | | (Cr25%,Ni20%) |
| A-13 | Graphite | 0.5 | Cr/Mo | 5/2 | Fe/Ni | H₂/N₂ | 1000 | 50 | FeCrNiMo |
| | | | | | | | | | (Cr18%,Ni12%,Mo2%) |
| A-14 | Graphite | 0.5 | Sn/SnO₂ | 5/2 | Ni | H₂ | 1100 | 30 | NiSn(Sn23%) |
| A-15 | Carbon | 10 | SnO₂ | 2 | Ni | H₂ | 1100 | 30 | NiSn(Sn23%) |
| | black | | | | | | | | |
| B-1 | None | | Cr | 5 | Ni | H₂/N₂ | 1000 | 50 | NiCr(Cr30%) |
| B-2 | None | | CuO | 2 | Ni | H₂ | 1100 | 30 | NiCu(Cu24%) |
| B-3 | None | | Al | 10 | Al | H₂/N₂ | 1000 | 50 | Al |
| B-4 | None | | Cr | 5/2 | Fe/Ni | H₂/N₂ | 1000 | 50 | FeCrNi |
| | | | | | | | | | (Cr25%,Ni20%) |
| B-5 | None | | Cr/Mo | 5/2 | Fe/Ni | H₂/N₂ | 1000 | 50 | FeCrNiMo |
| | | | | | | | | | (Cr18%,Ni12%,Mo2%) |
| B-6 | Graphite | 0.5 | Cr | 13 | Ni | H₂/N₂ | 1000 | 50 | NiCr |
| | | | | | | | | | (Cr30%) |
| B-7 | Carbon | 13 | SnO₂ | 2 | Ni | H₂ | 1100 | 30 | NiSn |
| | black | | | | | | | | (Sn23%) |

### <Evaluation Methods>

### (Oxygen Concentration in Metal)

The oxygen concentrations of the porous metallic bodies obtained above were measured by the fusion-infrared absorption method. The results are described in Table II.

(Measurement of t/D)

The average crystal grain diameter D in the skeleton of each porous metallic body was measured with a scanning electron microscope (SEM). The relationship t/D between the average crystal grain diameter D and a thickness t of the skeleton of the porous metallic body was determined. The results are described in Table II.

The average crystal grain diameter D was calculated from average values of the long and short sides of 10 crystal grains that were observed in the surface of the skeleton of the porous metallic body with the SEM.

The thickness t of the skeleton was determined in the following manner. A section of the porous metallic body was divided into three regions in the thickness direction. These regions were defined as a front surface portion, a middle portion, and a back surface portion. In each of these region portions, three points in the skeleton were selected. In total, the thickness of the skeleton was measured at nine points. In each point in the skeleton, thicknesses for three sides (not measured for the edge portions) were measured. Thus, there were three items (front surface/middle/back surface), three items (three points in skeleton), and three items (three sides); and, in total, data relating to 27 thicknesses were determined. The average value of these thicknesses was determined as the thickness t of the skeleton.

### (180° Bending Test)

Regarding an index indicating the electrode-production processibility of each porous metallic body obtained above, the porous metallic body was bent by 180° and the degree of cracking occurring in the bent portion was evaluated. The results are described in Table II.

### (Porosity in Skeleton Section)

In a section of the skeleton of each porous metallic body obtained above, a porosity was calculated by dividing the area of voids by the area of the skeleton (including the void portions). The results are described in Table II.

### (Evaluation of Corrosion Resistance)

In order to check whether the porous metallic bodies obtained above are applicable to lithium-ion batteries or capacitors or not, each porous metallic body was evaluated in terms of corrosion resistance by cyclic voltammetry. Regarding the evaluation size, each sample part was prepared so as to have dimensions of 0.4 mm (thickness, adjusted with a roller press) by 3 cm by 3 cm. Prepared were such a sample part having cut surfaces and another sample part not having any cut surface (prepared with a 3 cm by 3 cm three-dimensional network resin). An aluminum tab was welded as a lead wire and a microporous membrane separator was sandwiched to provide an aluminum laminate cell. A reference electrode was pressed onto a nickel tab. An electrolytic solution was used that contained 1 mol/L of LiPF₆ in 1:1 ethylene carbonate (Ec)/diethylene carbonate (DEC).

The measurement was performed in the potential range of 0 to 5 V with reference to the lithium potential. In applications to lithium-ion batteries or capacitors, it is necessary that oxidation current does not flow at a potential of 4.3 V. The potential was swept at a rate of 5 mV/s. The potential at which oxidation current started to flow was measured. The results are described in Table II.

TABLE II

| | Oxygen | | | | |
|---|---|---|---|---|---|
| | concentration in | | | Void ratio of | Potential at which |
| | metal after heat | | | skeleton section | oxidation current starts |
| Item | treatment [wt %] | t/D | 180° bending test | [%] | to flow [V] |
| A-1 | 0.37 | 0.83 | No cracking | 0.22 | 5 or more |
| A-2 | 0.15 | 0.62 | No cracking | 0.15 | 4.6 |
| A-3 | 0.22 | 0.71 | No cracking | 0.13 | 4.4 |
| A-4 | 0.07 | 0.68 | No cracking | 0.05 | 4.4 |
| A-5 | 0.10 | 0.60 | No cracking | 0.09 | 3.2 |
| A-6 | 0.42 | 0.69 | No cracking | 0.32 | 4.4 |
| A-7 | 0.12 | 0.63 | No cracking | 0.14 | 3.4 |
| A-8 | 0.09 | 0.63 | No cracking | 0.01 | 4.6 |
| A-9 | 0.21 | 0.95 | No cracking | 0.12 | 5 or more |
| A-10 | 0.04 | 0.74 | No cracking | 0.03 | 4.4 |
| A-11 | 0.39 | 0.70 | No cracking | 0.25 | 4.5 |
| A-12 | 0.28 | 0.72 | No cracking | 0.18 | 4.6 |
| A-13 | 0.30 | 0.66 | No cracking | 0.22 | 4.8 |
| A-14 | 0.15 | 0.74 | No cracking | 0.24 | 4.6 |
| A-15 | 0.39 | 0.81 | No cracking | 0.35 | 4.5 |
| B-1 | 0.59 | 0.69 | Some cracking | 0.21 | 4.0 |
| B-2 | 4.20 | 0.65 | Some cracking | 0.31 | 2.1 |
| B-3 | 1.98 | 0.91 | Some cracking | 0.43 | 4.5 |
| B-4 | 1.10 | 0.88 | Some cracking | 0.25 | 4.4 |
| B-5 | 0.87 | 0.76 | Some cracking | 0.18 | 4.5 |
| B-6 | 0.41 | 1.23 | Some cracking | 0.48 | 4.6 |
| B-7 | 0.58 | 1.13 | Some cracking | 0.45 | 4.6 |

### (Metal Concentration Distribution After Heat Treatment)

The concentration distribution of an added metal component in a section of the skeleton of each porous metallic body obtained above was analyzed with a scanning electron microscope/energy dispersive X-ray spectrometer (SEM/EDX). The results are described in Table III.

TABLE III

| | MAX concentration of added | MIN concentration of added |
|---|---|---|
| | metal after heat treatment | metal after heat treatment |
| Item | [wt %] | [wt %] |
| A-1 | Al/32 | Al/29 |
| A-2 | Cr/31 | Cr/29 |
| A-3 | Mn/30 | Mn/30 |
| A-4 | W/32 | W/29 |
| A-5 | Fe/21 | Fe/20 |
| A-6 | Co/23 | Co/21 |
| A-7 | Cu/24 | Cu/23 |
| A-8 | Sn/23 | Sn/23 |
| A-9 | Al/100 | Al/100 |
| A-10 | Mo/32 | Mo/30 |
| A-11 | Ti/33 | Ti/31 |
| A-12 | Cr25/Ni22 | Cr23/Ni21 |
| A-13 | Cr19/Ni22/Mo2 | Cr18/Ni21/Mo2 |
| A-14 | Sn/23 | Sn/23 |
| A-15 | Sn/23 | Sn/23 |
| B-1 | Cr/32 | Cr/30 |
| B-2 | Cu/24 | Cu/24 |
| B-3 | Al/100 | Al/100 |
| B-4 | Cr26/Ni22 | Cr23/Ni21 |
| B-5 | Cr19/Ni21/Mo2 | Cr18/Ni21/Mo2 |
| B-6 | Cr/50 | Cr/16 |
| B-7 | Sn/23 | Sn/23 |

As described in Table II, the oxygen concentration was less than 0.50 wt % in each of Examples A-1 to A-15 and Comparative example B-6 in which a carbon powder having a volume-average particle size of 10 μm or less was added in the electrically conductive treatment; in contrast, the oxygen concentration was 0.50 wt % or more in each of Comparative examples B-1 to B-5 in which no carbon powder was added and B-7 in which a carbon powder having a volume-average particle size of more than 10 μm was added. This indicates that the carbon powders having a volume-average particle size of 10 μm or less in the electrically conductive coating layers function as reducing agents for the metal or metal oxide fine powders and the metal plating layers.

It has also been demonstrated that no cracking occurred in the 180° bending test and high toughness was achieved in each of Examples A-1 to A-15 in which a carbon powder having a volume-average particle size of 10 μm or less was added in the electrically conductive treatment; in contrast, in each of Comparative examples B-1 to B-5 in which no carbon powder was added, the metal or metal oxide fine powders and the metal plating layers were not completely reduced and were present in the oxidized state providing a low breaking strength and a low breaking extension, and cracking occurred in the 180° bending test.

In Comparative example B-6 in which a carbon powder having a volume-average particle size of 10 μm or less was added, the metal powder had a volume-average particle size of more than 10 μm and hence cracking occurred. In Comparative example B-7 in which a carbon powder was added, since the carbon powder had a volume-average particle size of more than 10 μm, as described above, the metal oxide fine powder and the metal plating layer were not sufficiently reduced, which probably resulted in the occurrence of cracking.

Comparative examples B-6 and B-7 in which t/D was 1 or more provided the results that cracking occurred in the 180° bending test. In Comparative examples B-1 to B-5 in which t/D was less than 1, since no carbon powder was added, the metal oxide fine powders and the metal plating layers were not sufficiently reduced and cracking occurred.

As described in Table II, Examples A-1 to A-15 and Comparative examples B-1 to B-7 were each found to have a porosity of less than 1%. This indicates that, in the formation of the skeleton of a porous metallic body, a metal or metal oxide fine powder disposed on the surface of the skeleton is coated with a metal plating layer, so that the resultant skeleton has a section having a porosity of less than 1%.

As described in Table II, the following has been demonstrated: in Examples A-5 and A-7, oxidation current starts to flow before 4.3 V is reached; in contrast, in the other Examples, oxidation current does not flow even at potentials of 4.3 V or more. On the other hand, in Comparative examples B-1 and B-2, oxidation current starts to flow before 4.3 V is reached; in contrast, in Comparative examples B-3 to B-7, oxidation current does not flow even at potentials of 4.3 V or more.

The above-described evaluation results indicate that, among porous metallic bodies according to the present invention, at least porous bodies formed of Ni—Al, Ni—Cr, Ni—Mn, Ni—W, Ni—Co, Ni—Sn, Al, Ni—Mo, Ni—Ti, Fe—Cr—Ni, and Fe—Cr—Ni—Mo can be used as collectors for secondary batteries such as lithium-ion batteries, capacitors, and fuel cells, the collectors being required to have high mechanical characteristics and high corrosion resistance.

Table III indicates that, in each of Examples A-1 to A-15 and Comparative examples B-1 to B-5 and B-7, a uniform concentration is achieved in the section of the skeleton; in contrast, a concentration gradient is present in Comparative example B-6. This indicates that it is difficult to achieve uniform thermal diffusion of an added metal fine powder having a particle size of more than 10 μm.

### INDUSTRIAL APPLICABILITY

Porous metallic bodies according to the present invention are excellent in terms of mechanical characteristics and corrosion resistance and can be produced at a low cost. Accordingly, the porous metallic bodies can be suitably used as collectors for secondary batteries such as lithium-ion batteries, capacitors, and fuel cells.

### REFERENCE SIGNS LIST

1 metal skeleton

2 continuous pore

3 void

4 three-dimensional network resin

5 coating film of electrically conductive coating material containing carbon powder and metal or metal oxide fine powder

6 metal plating layer

1. A method for producing a porous metallic body, the method at least comprising:
a step of forming an electrically conductive coating layer on a surface of a skeleton of a three-dimensional network resin having a continuous pore by coating the surface with a coating material containing a carbon powder having a volume-average particle size of 10 μm or less and at least one fine powder having a volume-average particle size of 10 μm or less and selected from the group consisting of metal fine powders and metal oxide fine powders;
a step of forming at least one metal plating layer; and
a step of performing a heat treatment to remove the three-dimensional network resin and to cause reduction and thermal diffusion in the at least one metal or metal oxide fine powder and the at least one metal plating layer.

2. The method for producing a porous metallic body according to claim 1, wherein the coating material contains at least one metal fine powder having a volume-average particle size of 10 μm or less and formed of a metal selected from the group consisting of Al, Ti, Cr, Mn, Fe, Co, Ni, Cu, Mo, Sn, and W.

3. The method for producing a porous metallic body according to claim 1, wherein the coating material contains at least one metal oxide fine powder having a volume-average particle size of 10 μm or less and formed of a metal oxide selected from the group consisting of Al₂O₃, TiO₂, Cr₂O₃, MnO₂, Fe₂O₃, Co₃O₄, NiO, CuO, MoO₃, SnO₂, and WO₃.

4. The method for producing a porous metallic body according to claim 1, wherein the at least one metal plating layer is formed of a metal selected from the group consisting of Al, Al alloy, Cr, Cr alloy, Fe, Fe alloy, Ni, Ni alloy, Cu, Cu alloy, Zn, Zn alloy, Sn, and Sn alloy.

5. The method for producing a porous metallic body according to claim 1, wherein, in the heat-treatment step, the at least one metal or metal oxide fine powder and the at least one metal plating layer are reduced with the carbon powder contained in the electrically conductive coating layer.

6. The method for producing a porous metallic body according to claim 1, wherein the thermal diffusion causes alloy formation.

7. A porous metallic body produced by the method for producing a porous metallic body according to claim 1.

8. The porous metallic body according to claim 7, wherein the porous metallic body is formed of Ni—Al, Ni—Cr, Ni—Mn, Ni—W, Ni—Co, Ni—Sn, Al, Ni—Mo, Ni—Ti, Fe—Cr—Ni, or Fe—Cr—Ni—Mo.

9. A porous metallic body having a continuous pore, wherein the porous metallic body is formed of at least one metal selected from the group consisting of Al, Ti, Cr, Mn, Fe, Co, Ni, Cu, Mo, Sn, and W,
a relationship between a thickness t of a skeleton of the porous metallic body and an average crystal grain diameter D in the skeleton satisfies a formula described below,
an oxygen concentration in metal is less than 0.5 wt %, and
a section of the skeleton has a porosity of less than 1%
t/D≦1.0.
